(19) United States
(12) Patent Application Publication
(10) Pub. No.: US 2026/0368766 A1
(43) Pub. Date: Nov. 19, 2026

(54) CUSTOMER NUMBER PREDICTION DEVICE, LEARNING DEVICE, CUSTOMER NUMBER PREDICTION METHOD, LEARNING METHOD, AND PROGRAM

(71) Applicant: NTT, Inc., Tokyo (JP)

(72) Inventors: Jun ITO, Musashino-shi, Tokyo (JP); Hiroyuki SATO, Musashino-shi, Tokyo (JP); Noriko YOKOYAMA, Musashino-shi, Tokyo (JP); Takahiro HATA, Musashino-shi, Tokyo (JP); Masato KAMIYA, Musashino-shi, Tokyo (JP)

(73) Assignee: NTT, Inc., Tokyo (JP)

(21) Appl. No.: 19/133,735

(22) PCT Filed: Dec. 2, 2022
(86) PCT No.: PCT/JP2022/044634

§ 371 Date: May 29, 2025

(51) Int. Cl. G06Q 30/0202

(52) U.S. Cl. CPC G06Q 30/02023

(57) ABSTRACT

A number of customers prediction device is a number of customers prediction device that predicts a number of customers indicating a number of people who have performed a purchase behavior in a store, and includes: an acquisition unit configured to acquire an explanatory variable used to predict the number of customers; and a prediction unit configured to acquire a number of customers predicted value by inputting the explanatory variable acquired by the acquisition unit to a model that outputs the number of customers predicted value that is a predicted value of the number of customers during business hours of a day when the explanatory variable is input, and calculate the number of customers at each time on a basis of a cumulative distribution function used to calculate a ratio of a number of store visitors at each time to the number of store visitors that is a number of people who visit the store during the business hours of a day, and the number of customers predicted value.

### TECHNICAL FIELD

The disclosed technology relates to a number of customers prediction device, a learning device, a number of customers prediction method, a learning method, and a computer program.

### BACKGROUND ART

Conventionally, in a restaurant or the like, the number of customers on a future date has been predicted on the basis of past payment data recorded by a point of sale (POS) terminal. The prediction granularity of the number of customers is sometimes performed not only on a daily basis but also on a fine granularity of less than a day such as an hourly basis. For example, Non Patent Literature 1 discloses a technique related to sales of a restaurant and demand prediction of customers, and shows that time is handled in units of month, week, day of the week, and hour.

### CITATION LIST

### Non Patent Literature

Non Patent Literature 1: Agnieszka Lasek1, Nick Cercone1, and Jim Saunders, “Restaurant Sales and Customer Demand Forecasting: Literature Survey and Categorization of Methods”, ICST Institute for Computer Sciences, Social Informatics and Telecommunications Engineering 2016 A. Leon-Garcia et al. (Eds.): Smart City 2015, LNICST 166, pp. 479-491, 2016.

### SUMMARY OF INVENTION

### Technical Problem

However, for example, in a case where a payment method in a store is post-meal payment, payment timing is predicted, and thus there is a problem that it is difficult to use the number of customers predicted value with a granularity of less than a day in order to determine a pre-cooking amount for the purpose of shortening the time from order to meal provision.

Since a stay time varies depending on a customer, in a simple method of shifting the predicted value of the payment timing forward by an average stay time, a distribution shape is different between an actual store visit time distribution and a payment time distribution, and thus there is a problem that prediction accuracy is not sufficient.

There is also a method in which the number of store visitors measured by a number of store visitors measurement device such as a camera equipped with artificial intelligence (AI) installed at a store entrance is regarded as the number of customers. However, there is a problem that the number of store visitors cannot be regarded as the number of customers because there is a gap between the number of store visitors and the number of customers who actually performs purchase due to reasons such as insufficient recognition accuracy of the camera equipped with the AI due to the presence of people who come to the store but do not perform purchase or an influence of congestion.

The disclosed technology has been made in view of the above points, and an object thereof is to provide a number of customers prediction device, a number of customers prediction method, and a number of customers prediction program capable of accurately predicting the number of customers who performs a purchase behavior in a store from the number of store visitors who visits to the store.

### Solution to Problem

The first aspect of the present disclosure is a number of customers prediction device is a number of customers prediction device that predicts a number of customers indicating a number of people who have performed a purchase behavior in a store, and includes: an acquisition unit configured to acquire an explanatory variable used to predict the number of customers; and a prediction unit configured to acquire a number of customers predicted value by inputting the explanatory variable acquired by the acquisition unit to a model that outputs the number of customers predicted value that is a predicted value of the number of customers during business hours of a day when the explanatory variable is input, and calculate the number of customers at each time on a basis of a cumulative distribution function used to calculate a ratio of a number of store visitors at each time to the number of store visitors that is a number of people who visit the store during the business hours of a day, and the number of customers predicted value.

The second aspect of the present disclosure is a learning device that learns a model used to predict a number of customers indicating a number of people who have performed a purchase behavior in a store, the learning device including: a learning data acquisition unit configured to acquire learning data in which an explanatory variable used to predict the number of customers is associated with an actual value of the number of customers during business hours of a day; and a learning unit configured to learn the model that outputs a number of customers predicted value that is a predicted value of the number of customers when an explanatory variable fused to predict the number of customers is input on a basis of the learning data.

The third aspect of the present disclosure is a number of customers prediction method that predicts a number of customers indicating a number of people who have performed a purchase behavior in a store, in which a computer executes processing including: acquiring an explanatory variable used to predict the number of customers; acquiring a number of customers predicted value by inputting the acquired explanatory variable to a model that outputs the number of customers predicted value that is a predicted value of the number of customers during business hours of a day when the explanatory variable is input, and calculating the number of customers at each time on a basis of a cumulative distribution function used to calculate a ratio of a number of store visitors at each time to the number of store visitors that is a number of people who visit the store during the business hours of a day, and the number of customers predicted value.

The fourth aspect of the present disclosure is a learning method that learns a model used to predict a number of customers indicating a number of people who have performed a purchase behavior in a store, in which a computer executes processing including: acquiring learning data in which an explanatory variable used to predict the number of customers is associated with an actual value of the number of customers during business hours of a day; and learning the model that outputs a number of customers predicted value that is a predicted value of the number of customers when an explanatory variable fused to predict the number of customers is input on a basis of the learning data.

### Advantageous Effects of Invention

According to the disclosed technology, there is an effect of accurately predicting the number of customers who performs a purchase behavior in a store from the number of visitors who visits the store.

### BRIEF DESCRIPTION OF DRAWINGS

FIG. 1 is a block diagram illustrating an example of a hardware configuration of a number of customers prediction device according to a first embodiment.

FIG. 2 is a block diagram illustrating an example of a functional configuration of the number of customers prediction device according to the first embodiment.

FIG. 3 is a diagram illustrating an example of data stored in a data storage unit.

FIG. 4 is a diagram illustrating an example of the data stored in the data storage unit.

FIG. 5 is a diagram illustrating an example of the data stored in the data storage unit.

FIG. 6 is a diagram illustrating an example of the data stored in the data storage unit.

FIG. 7 is a diagram illustrating an example of the data stored in the data storage unit.

FIG. 8 is a diagram for describing an operation of a number of customers prediction device according to a first embodiment.

FIG. 9 is a diagram for describing the operation of the number of customers prediction device according to the first embodiment.

FIG. 10 is a diagram for describing the operation of the number of customers prediction device according to the first embodiment.

FIG. 11 is a diagram illustrating an example of a cumulative distribution function.

FIG. 12 is a diagram for describing an operation of a number of customers prediction device according to a second embodiment.

### DESCRIPTION OF EMBODIMENTS

Hereinafter, an example of an embodiment of the disclosed technology will be described with reference to the drawings. Note that in the drawings, the same or equivalent components and portions will be denoted by the same reference numerals. Further, dimensional ratios in the drawings are exaggerated for convenience of description and thus may be different from actual ratios.

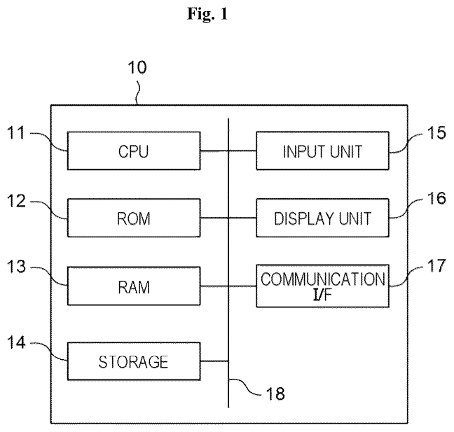

First, a hardware configuration of a number of customers prediction device 10 according to the present embodiment will be described with reference to FIG. 1.

FIG. 1 is a block diagram illustrating an example of a hardware configuration of the number of customers prediction device 10 according to the present embodiment.

As illustrated in FIG. 1, the number of customers prediction device 10 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 18.

The CPU 11 is a central processing unit, and executes various programs and controls each unit. In other words, the CPU 11 reads out a program from the ROM 12 or the storage 14 and executes the program using the RAM 13 as a working area. The CPU 11 controls, in accordance with the program stored in the ROM 12 or the storage 14, each of the components described above and carries out various types of arithmetic processing. In the present embodiment, a learning program and a number of customers prediction program are stored in the ROM 12 or the storage 14.

The ROM 12 stores various programs and various types of data. The RAM 13 temporarily stores the programs and data as a working area. The storage 14 includes a hard disk drive (HDD) or a solid state drive (SSD) and stores various programs including an operating system and various types of data.

The input unit 15 includes a pointing device such as a mouse and a keyboard and is used to perform various inputs to its own device.

The display unit 16 is, for example, a liquid crystal display and displays various types of information. The display unit 16 may also function as the input unit 15 by adopting a touch panel system.

The communication interface 17 is an interface through which its own device communicates with another external device. For the communication, for example, wired communication standards such as Ethernet (registered trademark) or fiber distributed data interface (FDDI), or wireless communication standards such as 4G, 5G, or Wi-Fi (registered trademark) are used.

For example, a general-purpose computer device such as a server computer or personal computer (PC) is applied to the number of customers prediction device 10 according to the present embodiment.

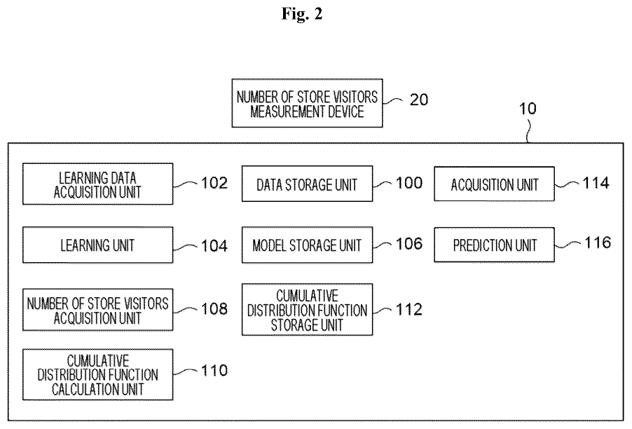

Next, a functional configuration of the number of customers prediction device 10 will be described with reference to FIG. 2.

FIG. 2 is a block diagram illustrating an example of a functional configuration of the number of customers prediction device 10 according to the present embodiment.

As illustrated in FIG. 2, the number of customers prediction device 10 includes, as a functional configuration, a data storage unit 100, a learning data acquisition unit 102, a learning unit 104, a model storage unit 106, a number of store visitors acquisition unit 108, a cumulative distribution function calculation unit 110, a cumulative distribution function storage unit 112, an acquisition unit 114, and a prediction unit 116. Each functional configuration is achieved by the CPU 11 reading the learning program and the number of customers prediction program stored in the ROM 12 or the storage 14, loading the programs to the RAM 13, and executing the programs. Note that the number of store visitors data output from a number of store visitors measurement device 20 such as an AI camera is stored in the data storage unit 100. The number of customers prediction device 10 predicts the number of customers indicating the number of people who have performed a purchase behavior in a store.

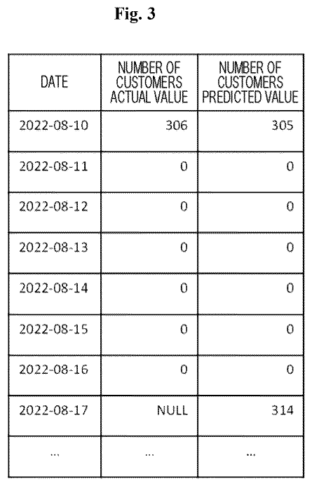

FIG. 3 is an example of number of customers data stored in the data storage unit 100. In the number of customers data, a number of customers actual value and a number of customers predicted value are associated with each other for each date. The number of customers predicted value is data output from the prediction unit 116 to be described below.

The number of customers actual value is an actual value of the number of customers. A missing value is expressed by NULL, and for example, the number of customers actual value in 2022-08-17 in FIG. 3 is unmeasured.

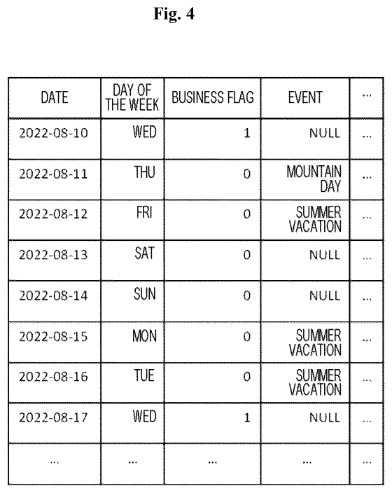

FIG. 4 is an example of event data stored in the data storage unit 100. In the event data, a day of the week, a business flag, an event, and the like are associated with each date. The business flag is expressed by, for example, 1 for a business day and 0 for a non-business day. The event is expressed by, for example, a name of a holiday or a name expressing a temporary holiday such as a summer holiday, and is expressed by NULL or the like when there is no special event. Note that, regarding the event data, information other than those illustrated in FIG. 4 may be expressed.

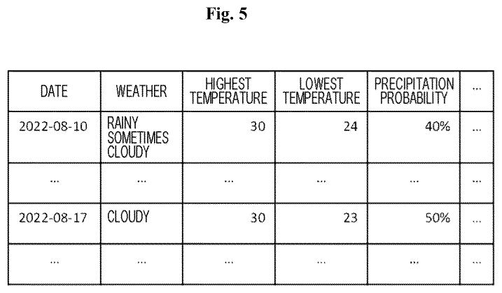

FIG. 5 is an example of weather data stored in the data storage unit 100. In the weather data, weather, highest temperature, lowest temperature, precipitation probability, and the like are associated with one another for each date. The weather is expressed by, for example, a name such as rainy and sometimes cloudy, or cloudy. The highest temperature or the lowest temperature is expressed by, for example, a numerical value such as 30 or 24. The precipitation probability is expressed by, for example, a percentage such as 40%. Regarding the weather data, information other than those illustrated in FIG. 5 may be expressed.

The data illustrated in FIGS. 4 to 5 are external variables representing an external environment.

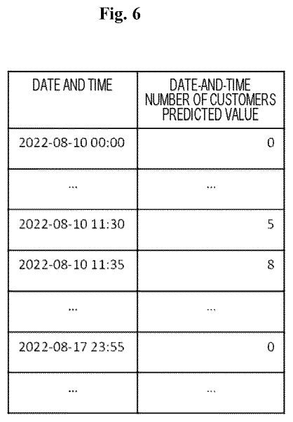

FIG. 6 is an example of date-and-time number of customers data created by the prediction unit 116 to be described below. The date-and-time number of customers data has a date-and-time number of customers predicted value for each date and time. In the example of FIG. 6, a record is stored every five minutes, but a time interval may be arbitrary.

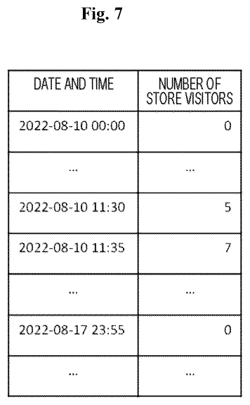

FIG. 7 is an example of the number of store visitors data stored in the data storage unit 100. The number of store visitors data has the number of store visitors for each date and time. In the example of FIG. 7, a record is stored every five minutes, but the time interval may be arbitrary.

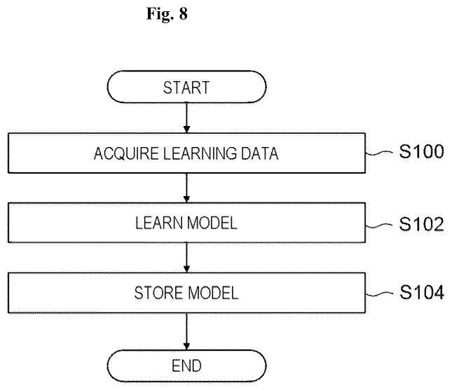

Next, the operation of the number of customers prediction device 10 according to the present embodiment will be described with reference to FIGS. 8 to 10.

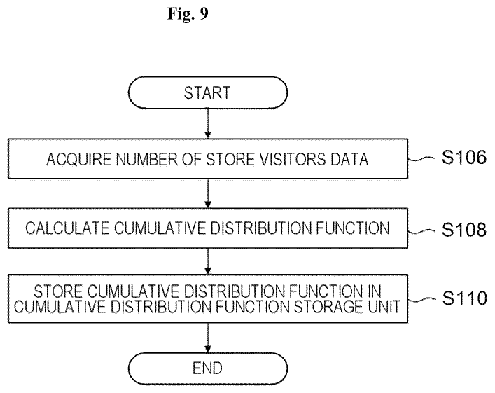

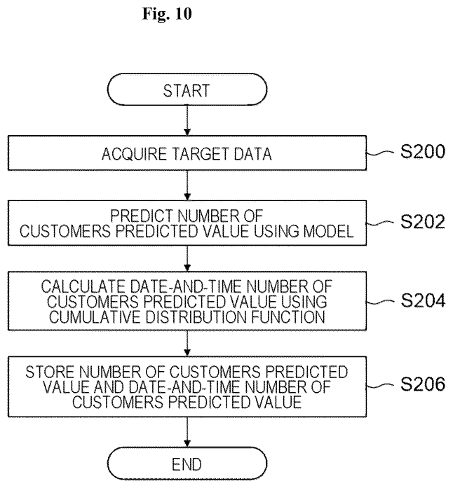

FIGS. 8 and 9 are flowcharts illustrating an example of a flow of processing by the learning program according to the present embodiment. FIG. 10 is a flowchart illustrating an example of a flow of processing by the number of customers prediction program according to the present embodiment. The processing by the learning program is implemented by the CPU 11 of the number of customers prediction device 10 writing the learning program stored in the ROM 12 or the storage 14 to the RAM 13 and executing the learning program. The processing by the number of customers prediction program is implemented by the CPU 11 of the number of customers prediction device 10 writing the number of customers prediction program stored in the ROM 12 or the storage 14 to the RAM 13 and executing the number of customers prediction program.

When receiving a control signal indicating a model learning instruction, the number of customers prediction device 10 executes learning processing of FIG. 8.

First, in step S100 of FIG. 8, the CPU 11 as the learning data acquisition unit 102 acquires, from the data stored in the data storage unit 100, data in which the external variables representing the external environment as explanatory variables are associated with actual values of the number of customers during business hours of a day, as learning data. Specifically, the learning data is obtained by connecting the number of customers actual value of the number of customers data, the event data, and the weather data for each date.

In step S102, the CPU 11 as the learning unit 104 learns a model that outputs the number of customers predicted value that is a predicted value of the number of customers when the external variables representing the external environment as the explanatory variables are input on the basis of the learning data acquired in step S100. The external variables mean data items excluding the number of customers actual value, and are for example, an event, weather, and the like. The model is implemented by machine learning that solves a regression problem with the number of customers actual value as an objective variable and the external variables as explanatory variables.

In step S104, the CPU 11 as the learning unit 104 causes the model storage unit 106 to store the model obtained in step S102.

Next, the number of customers prediction device 10 executes learning processing of FIG. 9.

First, in step S106 of FIG. 9, the CPU 11 as the number of store visitors acquisition unit 108 acquires the number of store visitors data from the data stored in the data storage unit 100. Normally, the number of store visitors data of an entire period recorded in the data storage unit 100 is acquired. However, in a case where a trend of a store visit situation is different between the past and the latest, it is also possible to cope with a trend change by In step S108, the CPU 11 as the cumulative distribution function calculation unit 110 calculates a cumulative distribution function on the basis of the number of store visitors data acquired in step S106.

Specifically, the cumulative distribution function calculation unit 110 first calculates an average value of the number of store visitors for each fixed date and time unit. For example, in the case of the unit of 5 minutes, the cumulative distribution function calculation unit 110 calculates the average value of the number of store visitors for each time range of [00:00,00:05), [00:05,00:10), . . . , [23: 55,00:00). Therefore, for example, the average value of a case where the number of store visitors in the range of [11:30,11:35) is [5,6,7,4] is 5.5. The cumulative distribution function calculation unit 110 performs similar calculation in all time ranges.

Next, the cumulative distribution function calculation unit 110 calculates the cumulative distribution function on the basis of the average value for each time range. For example, it is assumed that business start time is 11:30, the number of store visitors until then is 0, the average value for each time range of “11:30,11:35), “11:35,11:40), “11:40,11:45), . . . is [5.5,7,20.5, . . . ] , and a sum of the average values in the entire time range is 200. In this case, the cumulative distribution function is calculated such that the sum of the average values in the time range of [11:30,11:35) is 5.5 and thus 5.5÷200=0.0275, the sum of the average values in the time range of [11:35,11:40) is 12.5 in total and thus 0.0625, and the sum of the average values in the time range of [11:40,11:45) is 33 in total and thus 0.165. Since the cumulative distribution function is 0 before the business start time and 1 after business end time, a value range of the cumulative distribution function is [0,1]. Note that a median value may be calculated instead of calculating the average value of the number of store visitors for each fixed date and time unit. Therefore, the cumulative distribution function is a function for calculating a ratio of the number of store visitors at each time to the number of store visitors that is the number of people who visit the store during the business hours of a day.

In step S110, the CPU 11 as the cumulative distribution function calculation unit 110 causes the cumulative distribution function storage unit 112 to store the cumulative distribution function calculated in step S108.

Next, when receiving a control signal indicating a number of customers prediction instruction, the number of customers prediction device 10 executes number of customers prediction processing of FIG. 10.

In step S200, the CPU 11 as the acquisition unit 114 acquires target data from the data storage unit 100. The target data is data in a format similar to that of the learning data, but is different from the learning data in that the number of customers actual value in a prediction target period is not included. Specifically, the target data is data including the external variables representing the external environment and the explanatory variables.

In step S202, the CPU 11 as the prediction unit 116 acquires the number of customers predicted value output from the model by inputting the external variables that are the target data acquired in step S200 to the model stored in the model storage unit 106. Note that the number of customers predicted value output from the model is the predicted value of the number of customers of the store during the business hours of a day.

In step S204, the CPU 11 as the prediction unit 116 calculates the date-and-time number of customers predicted value on the basis of the cumulative distribution function stored in the cumulative distribution function storage unit 112 and the number of customers predicted value during the business hours of a day acquired in step S202.

For example, it is assumed that the cumulative distribution function is [0.0275,0.0625,0.165, . . . ] in the time range of [11:30,11:35), [11:35,11:40), [11:40,11:45), . . . , and the number of customers predicted value is 250. In this case, the date-and-time number of customers predicted value of [11:30,11:35) is calculated as 0.0275×250=6.875, the date-and-time number of customers predicted value of [11:35,11:40) is calculated as (0.0625−0.0275)×250 =8.82, and the date-and-time number of customers predicted value of [11:40,11:45) is calculated as (0.165−0.0625)×250=25.625. In addition, rounding of the date-and-time number of customers predicted value to the decimal place is performed by rounding off, rounding up, rounding down, or the like. For example, when rounding off is used, each date-and-time number of customers predicted value above is [7,9,26, . . . ].

In step S206, the CPU 11 as the prediction unit 116 causes the data storage unit 100 to store the number of customers predicted value acquired in step S202 and the date-and-time number of customers predicted value acquired in step S204.

As described above, the number of customers prediction device acquires the external variables representing the external environment as the explanatory variables, and acquires the number of customers predicted value during the business hours of a day by inputting the acquired external variables to the model that outputs the number of customers predicted value that is the predicted value of the number of customers during the business hours of a day when the external variables are input. Then, the number of customers prediction device calculates the number of customers prediction at each time on the basis of the cumulative distribution function for calculating the ratio of the number of store visitors at each time to the number of store visitors that is the number of people who visit the store during the business hours of a day, and the number of customers predicted value during the business hours of a day. Thereby, it is possible to accurately predict the number of customers who performs a purchase behavior in a store from the number of visitors who visits the store. In addition, for example, in a case where a visitor who visits the store does not immediately perform the purchase behavior, for example, it is possible to accurately perform the number of customers prediction (date-and-time number of customers prediction) with a granularity of less than a day. In addition, it is possible to make a total value of a day of the date-and-time number of customers predicted value the same as the number of customers predicted value (maintain consistency) while making the distribution of the number of customers similar to the distribution of the number of store visitors, and it is possible to implement the date-and-time number of customers prediction with high prediction accuracy.

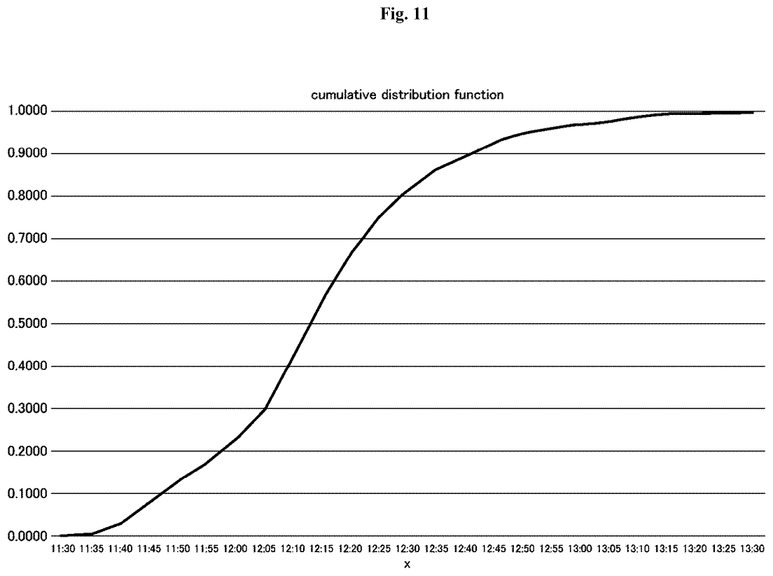

FIG. 11 illustrates an example of the cumulative distribution function. An x-axis illustrated in FIG. 11 represents the time range, and X=11:30 indicates the time range of [11:30,11:35). Note that, in this example, the business hours are [11:30,13:30), and the business hours before 11:30 and after 13:30 are omitted. A y-axis represents a value F(X) at X of the cumulative distribution function. A value range is [0,1], the value is 0 before 11:30 and is 1 after 13:30.

### Second Embodiment

Next, a second embodiment will be described. The second embodiment is different from the first embodiment in updating a number of customers predicted value during business hours of a store. Note that a number of customers prediction device according to the second embodiment has a configuration similar to that of the first embodiment, and the same reference numerals are given and description thereof is omitted.

Since the number of store visitors data on the day is accumulated as confirmation information after the store starts business, prediction accuracy is improved by re-predicting the number of customers predicted value. Therefore, a number of customers prediction device according to the second embodiment re-predicts the number of customers predicted value at regular time intervals or at arbitrary timing.

Note that the number of customers prediction device of the second embodiment acquires not only target data used in the first embodiment but also number of store visitors data. Further, the number of customers prediction device according to the second embodiment performs new processing in a period from acquisition of a cumulative distribution function to calculation of a date-and-time number of customers predicted value. Hereinafter, specific description will be given.

When receiving a control signal indicating a number of customers prediction instruction, the number of customers prediction device 10 according to the second embodiment executes number of customers prediction processing of FIG. 13.

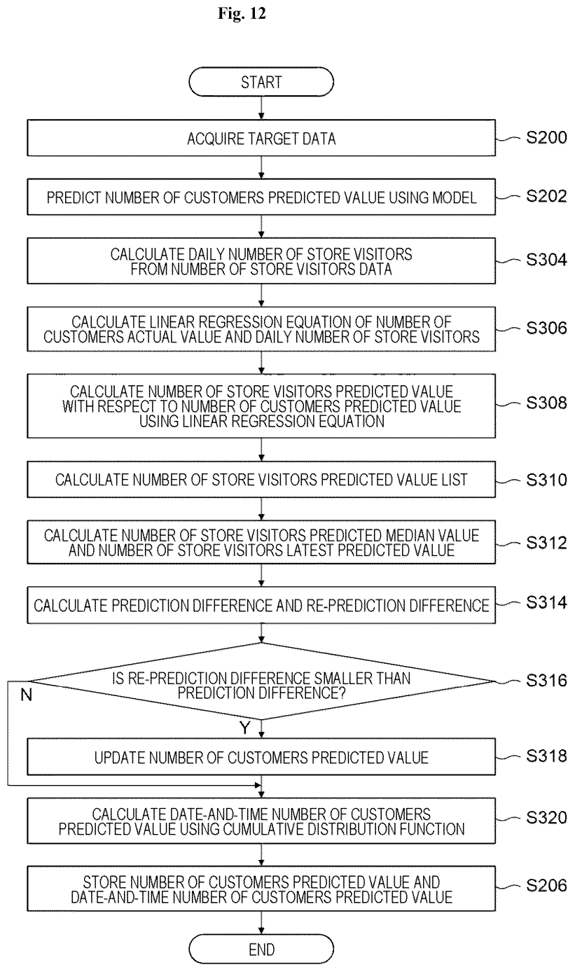

Steps S200 to S202 in FIG. 12 are executed similarly to the first embodiment.

In step S304, the CPU 11 as the number of store visitors acquisition unit 108 acquires the number of store visitors data from the data storage unit 100 and calculates a daily number of store visitors from the number of store visitors data. The daily number of store visitors is obtained by aggregating the number of store visitors recorded on a date and time basis on a date basis. Therefore, the daily number of store visitors is also the number of store visitors during the business hours of a day of the store.

In step S306, the CPU 11 as the prediction unit 116 calculates a linear regression equation of the number of customers actual value stored in the data storage unit 100 and the daily number of store visitors calculated in step S304. A linear regression equation such as y=0.7x+10 is obtained by linear regression with the x-axis as the number of store visitors in a day and the y-axis as the number of customers in a day.

In step S308, the CPU 11 as the prediction unit 116 calculates a number of store visitors predicted value during the business hours of a day (hereinafter also simply referred to as a first predicted value) on the basis of the number of customers predicted value during the business hours of a day (hereinafter also simply referred to as a number of customers predicted value) calculated in step S202 and the linear regression equation obtained in step S306. For example, in a case where the number of customers predicted value is 157, the first predicted value that is the number of store visitors predicted value is x=(157−10)÷0.7=210.

In step S310, the CPU 11 as the prediction unit 116 acquires the number of store visitors data of a prediction date. Then, the prediction unit 116 calculates a number of store visitors predicted value list representing a series of second predicted values of the number of store visitors during the business hours of a day at each time on the basis of the number of store visitors data of the prediction date and the cumulative distribution function.

For example, it is assumed that the number of store visitors data on the prediction date is 5 for “2022-08-17 11:30”, 8 for “2022-08-17 11:35”, and 19 for “2022-08-17 11:40”. In this case, it is assumed that the cumulative distribution function is [0.0275,0.0625,0.165, . . . ] in the time range of [11:30,11:35), [11:35,11:40), [11:40,11:45), . . . . At this time, the number of store visitors until 11:30 is calculated as 5÷0.0275≈182, and the number of store visitors until 11:35 is calculated as (5+8)÷0.0625=208. Hereinafter, the number of store visitors predicted value list that is the series of the second predicted values of the number of store visitors is calculated as [182,208,194] by similar calculation.

In step S312, the CPU 11 as the prediction unit 116 calculates a number of store visitors representative predicted value and a number of store visitors latest predicted value from the first predicted value calculated in step S308 and the number of store visitors predicted value list calculated in step S310. Note that the number of store visitors representative predicted value is a median value or an average value in a list obtained by combining the first predicted value and the number of store visitors predicted value list.

For example, in a case where the first predicted value is 210 and the number of store visitors predicted value list is [182,208,194] (each element in this list corresponds to the second predicted value), the number of store visitors representative predicted value is the median value of [182,194,208,210] in which all the values are arranged in ascending order, and thus the number of store visitors representative predicted value is (194+208)÷2=201. Meanwhile, in a case where the number of elements of the number of store visitors predicted value list is an even number (for example, [182,208]), the number of store visitors representative predicted value is the median value of [182,208,210] and thus is 208.

Furthermore, the prediction unit 116 sets a tail value of the number of store visitors predicted value list as the number of store visitors latest predicted value. For example, when the number of store visitors predicted value list is [182,208, 194], the number of store visitors latest predicted value is 194.

In step S314, the CPU 11 as the prediction unit 116 calculates a first prediction difference (hereinafter also referred to as a prediction difference) that is a difference between the first predicted value calculated in step S308 and the number of store visitors representative predicted value calculated in step S312. Furthermore, the prediction unit 116 calculates a second prediction difference (hereinafter also referred to as a re-prediction difference) that is a difference between the first predicted value calculated in step S308 and the number of store visitors latest predicted value calculated in step S312. For example, the prediction difference is |210−201|=9 when the number of store visitors predicted value is 210 and the number of store visitors representative predicted value is 201. In addition, the re-prediction difference is |194−201|=7 when the number of store visitors latest predicted value is 194.

In step S316, the CPU 11 as the prediction unit 116 determines whether or not the re-prediction difference is smaller than the prediction difference. In a case where the re-prediction difference is smaller than the prediction difference, the processing proceeds to step S318. On the other hand, in a case where the re-prediction difference is equal to or larger than the prediction difference, the processing proceeds to step S320.

In step S318, the CPU 11 as the prediction unit 116 updates the number of customers according to the number of store visitors latest predicted value calculated in step S312 as the number of customers predicted value. Specifically, the prediction unit 116 calculates the number of customers for the number of store visitors latest predicted value using the linear regression equation calculated in step S306, and updates the calculated value as the number of customers predicted value. For example, in a case where the first predicted value is 210 and the number of store visitors predicted value list is [182,208, 194], the prediction difference is 9 and the re-prediction difference is 7, and thus the number of customers predicted value is updated. Assuming that the linear regression equation is y=0.7x+10, the updated number of customers predicted value is y=0.7×194+10≈146.

In step S320, the CPU 11 as the prediction unit 116 calculates the date-and-time number of customers predicted value on the basis of any one of the number of customers predicted value updated in step S318 and the number of customers predicted value predicted in step S202 and the cumulative distribution function.

Step S206 in FIG. 12 is executed similarly to the first embodiment.

As described above, the number of customers prediction device according to the second embodiment calculates the first predicted value of the number of store visitors during the business hours of a day on the basis of the number of customers predicted value during the business hours of a day and the calculation formula prepared in advance. The number of customers prediction device calculates a number of store visitors predicted value list representing a series of second predicted values of the number of store visitors during the business hours of a day at each time on the basis of the number of store visitors of the prediction date and the cumulative distribution function. The number of customers prediction device selects the number of store visitors representative predicted value that is a median value or an average value from the first predicted value of the number of store visitors and the second predicted value of the number of store visitors at each time in the number of store visitors predicted value list. The number of customers prediction device calculates the first prediction difference that is a difference between the first predicted value of the number of store visitors and the number of store visitors representative predicted value. The number of customers prediction device calculates the second prediction difference that is a difference between the first predicted value of the number of store visitors and the number of store visitors latest predicted value that is the latest predicted value in the number of store visitors predicted value list. Then, in the case where the second prediction difference is smaller than the first prediction difference, the number of customers prediction device updates the number of customers according to the number of store visitors latest predicted value as the number of customers predicted value. In this way, it is possible to perform the number of customers prediction and the date-and-time number of customers prediction with higher accuracy by performing the re-prediction using the determined number of store visitors data of the prediction date. In addition, even in a case where the number of customers predicted value predicted on the basis of the data up to the previous day is deviated, it is possible to update the number of customers predicted value by performing the re-prediction using the confirmed number of store visitors data, and it is possible to more accurately perform the number of customers prediction and the date-and-time number of customers prediction.

Note that, in the above embodiment, the case where the number of customers prediction device 10 executes the model learning processing and the number of customers prediction processing has been described as an example, but the present invention is not limited thereto. For example, a learning device may execute the model learning processing, and the number of customers prediction device may execute the number of customers prediction processing.

The processing executed by the CPU 11 reading the each program in the above embodiment may be executed by various processors other than the CPU 11. Examples of the processors in this case include a programmable logic device (PLD) in which a circuit configuration can be changed after manufacturing, such as a field-programmable gate array (FPGA), or the like, and a dedicated electric circuit, or the like, that is a processor having a circuit configuration exclusively designed for executing a specific process, such as an application specific integrated circuit (ASIC). In addition, each processing may be executed by one of the various processors or may be executed by a combination of two or more processors of the same type or different types (for example, a combination of a plurality of FPGAs or a combination of a CPU and an FPGA). Further, a hardware structure of these various processors is, more specifically, an electric circuit in which circuit elements such as semiconductor elements are combined.

Further, in the above embodiment, the aspect in which the program is stored (also referred to as “installed”) in advance in the ROM 12 or the storage 14 has been described, but the present embodiment is not limited thereto. The number of customers prediction program may be provided in the form of a program stored in a non-transitory storage medium such as a compact disk read only memory (CD-ROM), a digital versatile disk read only memory (DVD-ROM), or a universal serial bus (USB) memory. Furthermore, the program may be downloaded from an external device via a network.

All documents, patent applications, and technical standards described in this specification are incorporated herein by reference to the same extent as when a case where incorporation by reference of each document, patent application, and technical standard is specifically and individually described.

With regard to the above embodiments, the following supplementary notes are further disclosed.

### (Supplement 1)

A number of customers prediction device including:
a memory; and
at least one processor connected to the memory, in which,
in predicting a number of customers indicating a number of people who have performed a purchase behavior in a store,
the processor is configured to:
   acquire an explanatory variable used to predict the number of customers;
   acquire a number of customers predicted value by inputting the acquired explanatory variable to a model that outputs the number of customers predicted value that is a predicted value of the number of customers during business hours of a day when the explanatory variable is input; and
   calculate the number of customers at each time on a basis of a cumulative distribution function used to calculate a ratio of a number of store visitors at each time to the number of store visitors that is a number of people who visit the store during the business hours of a day, and the number of customers predicted value.

### (Supplement 2)

A non-transitory storage medium storing a program executable by a computer to execute number of customers prediction processing,
the number of customers prediction processing including:
   in predicting a number of customers indicating a number of people who have performed a purchase behavior in a store,
   acquiring an explanatory variable used to predict the number of customers;
   acquiring a number of customers predicted value by inputting the acquired explanatory variable to a model that outputs the number of customers predicted value that is a predicted value of the number of customers during business hours of a day when the explanatory variable is input; and
   calculating the number of customers at each time on a basis of a cumulative distribution function used to calculate a ratio of a number of store visitors at each time to the number of store visitors that is a number of people who visit the store during the business hours of a day, and the number of customers predicted value.

### (Supplement 3)

A learning device including:
a memory; and
at least one processor connected to the memory, in which,
in learning a model used to predict a number of customers indicating a number of people who have performed a purchase behavior in a store,
the processor is configured to:
   acquire learning data in which an explanatory variable used to predict the number of customers is associated with an actual value of the number of customers during business hours of a day; and
   learn the model that outputs a number of customers predicted value that is a predicted value of the number of customers when an explanatory variable fused to predict the number of customers is input on a basis of the learning data.

### (Supplement 4)

A non-transitory storage medium storing a program executable by a computer to execute number of customers prediction processing,
the learning processing including:
   in learning a model used to predict a number of customers indicating a number of people who have performed a purchase behavior in a store,
   acquiring learning data in which an explanatory variable used to predict the number of customers is associated with an actual value of the number of customers during business hours of a day; and learning the model that outputs a number of customers predicted value that is a predicted value of the number of customers when an explanatory variable fused to predict the number of customers is input on a basis of the learning data.

### REFERENCE SIGNS LIST

10 Number of customers prediction device
100 Data storage unit
102 Learning data acquisition unit
104 Learning unit
106 Model storage unit
108 Number of store visitors acquisition unit
110 Cumulative distribution function calculation unit
112 Cumulative distribution function storage unit
114 Acquisition unit
116 Prediction unit

1. A number of customers prediction device comprising:
a memory; and
at least one processor connected to the memory, in which,
in predicting a number of customers indicating a number of people who have performed a purchase behavior in a store,
the processor is configured to:
acquire an explanatory variable used to predict the number of customers;
acquire a number of customers predicted value by inputting the explanatory variable to a model that outputs the number of customers predicted value that is a predicted value of the number of customers during business hours of a day when the explanatory variable is input; and
calculate the number of customers at each time on a basis of a cumulative distribution function used to calculate a ratio of a number of store visitors at each time to the number of store visitors that is a number of people who visit the store during the business hours of a day, and the number of customers predicted value.

2. The number of customers prediction device according to claim 1, wherein the processor is configured to:
calculates a first predicted value of the number of store visitors during the business hours of a day on a basis of the number of customers predicted value during the business hours of a day and a calculation formula prepared in advance,
calculates a number of store visitors predicted value list representing a series of second predicted values of the number of store visitors during the business hours of a day at each time on the basis of the number of store visitors on a prediction date and the cumulative distribution function,
selects a number of store visitors representative predicted value that is a median value or an average value from the first predicted value of the number of store visitors and the second predicted value of the number of store visitors at each time in the number of store visitors predicted value list,
calculates a first prediction difference that is a difference between the first predicted value of the number of store visitors and the number of store visitors representative predicted value,
calculates a second prediction difference that is a difference between the first predicted value of the number of store visitors and a number of store visitors latest predicted value that is a latest predicted value in the number of store visitors predicted value list, and
updates, in a case where the second prediction difference is smaller than the first prediction difference, a number of customers according to the latest number of store visitors predicted value as the number of customers predicted value.

3. (canceled)

4. A number of customers prediction method that predicts a number of customers indicating a number of people who have performed a purchase behavior in a store, in which a computer executes processing comprising:
by a processor,
acquiring an explanatory variable used to predict the number of customers;
acquiring a number of customers predicted value by inputting the acquired explanatory variable to a model that outputs the number of customers predicted value that is a predicted value of the number of customers during business hours of a day when the explanatory variable is input, and
calculating the number of customers at each time on a basis of a cumulative distribution function used to calculate a ratio of a number of store visitors at each time to the number of store visitors that is a number of people who visit the store during the business hours of a day, and the number of customers predicted value.

5. (canceled)

6. A non-transitory storage medium storing a program executable by a computer to execute number of customers prediction processing,
the number of customers prediction processing including:
in predicting a number of customers indicating a number of people who have performed a purchase behavior in a store,
acquiring an explanatory variable used to predict the number of customers;
acquiring a number of customers predicted value by inputting the acquired explanatory variable to a model that outputs the number of customers predicted value that is a predicted value of the number of customers during business hours of a day when the explanatory variable is input; and
calculating the number of customers at each time on a basis of a cumulative distribution function used to calculate a ratio of a number of store visitors at each time to the number of store visitors that is a number of people who visit the store during the business hours of a day, and the number of customers predicted value.
